(19) United States
(12) Patent Application Publication
(10) Pub. No.: US 2009/0244500 A1
(43) Pub. Date: Oct. 1, 2009

(54) PROJECTOR

(75) Inventor: Kiyoshi TAKARA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/405,464

(22) Filed: Mar. 17, 2009

(30) Foreign Application Priority Data
Mar. 26, 2008 (JP) 2008-079955

(51) Int. Cl. G03B 21/14

(52) U.S. Cl. 353/119

(57) ABSTRACT

A projector which projects an image includes: a housing which forms an external casing of the projector; a plurality of extensible and contractive legs which support the housing; a leg extension and contraction drive unit which extends or contracts at least one of the plural legs; an inclination detection unit which has a pendulum provided within the housing such that the pendulum can swing, and detects inclination of the housing with respect to a horizontal surface in the left-right direction based on inclination condition of the pendulum in the left-right direction to output inclination information based on a detection result; and an inclination correction unit which controls the leg extension and contraction drive unit based on the inclination information outputted from the inclination detection unit to correct inclination of the housing in the left-right direction.

### BACKGROUND

1. Technical Field

The present invention relates to a projector.

2. Related Art

When a projector is placed on an inclined surface in the left-right direction (left-right direction when the projection direction of the projector corresponds to the front) with respect to the horizontal surface, images projected on a screen by the projector are inclined in the left-right direction. For correcting the inclination of the projected images, any of legs provided on the left and right parts of the projector is extended or contracted to position the projector housing in horizontal condition. JP-A-8-251522 proposes a projection type display apparatus (projector) which detects inclination of the housing and controls the posture of the housing by moving legs which are freely extensible and contractive so as to display images having no distortion and inclination. As an example of inclination detector for detecting inclination of the housing, a spherical body is accommodated within a rectangular box such that the spherical body can freely shift therein, and a pressure sensor is disposed on a surface inside the rectangular box. In this structure, component force of gravity of the spherical body is detected for calculation of inclination.

For detecting inclination (angle) of the projector housing, however, an inclination detector having the pressure sensor and the like discussed above is required. In this case, the circuit structure and other components become complicated. Thus, such a projector capable of detecting inclination of the projector housing and correcting inclination of the housing in the left-right direction by a simple structure has been demanded.

### SUMMARY

It is an advantage of some aspects of the invention to provide a projector which can solve at least a part of the problems described above.

A projector which projects an image according to an aspect of the invention includes: a housing which forms an external casing of the projector; a plurality of extensible and contractive legs which support the housing; a leg extension and contraction drive unit which extends or contracts at least one of the plural legs; an inclination detection unit which has a pendulum provided within the housing such that the pendulum can swing, and detects inclination of the housing with respect to a horizontal surface in the left-right direction based on inclination condition of the pendulum in the left-right direction to output inclination information based on a detection result; and an inclination correction unit which controls the leg extension and contraction drive unit based on the inclination information outputted from the inclination detection unit to correct inclination of the housing in the left-right direction.

According to this structure, the inclination detection unit detects inclination of the housing in the left-right direction based on inclination condition of the pendulum as inclination information, and the inclination correction unit extends or contracts the legs based on the inclination information to correct inclination of the housing with respect to the horizontal surface in the left-right direction. This enables correction of inclination of the housing of the projector in the left-right direction with a simple structure using the pendulum. The expression “extends or contracts” refers to increase or decrease in the projection of the legs from the housing.

It is preferable that the extensible and contractive legs are provided on both the left and right parts of the housing.

According to this structure, the extensible and contractive legs are provided on both the left and right parts of the housing. Thus, inclination of the housing in the left-right direction can be corrected by using the legs on the left and right parts, and therefore the range of correction can be widened.

It is preferable that the inclination correction unit controls the leg extension and contraction drive unit in such a manner as to extend the leg contained in the legs disposed on the left and right parts and positioned on the lower side of inclination of the housing with respect to the horizontal surface based on the inclination information outputted from the inclination detection unit.

According to this structure, the inclination correction unit controls the leg extension and contraction drive unit in such a manner as to extend the leg positioned on the lower side of inclination of the housing. Thus, inclination of the projector housing in the left-right direction is controlled such that the position of the leg on the lower side can be adjusted to the position of the leg on the upper side. The expression “extension” refers to increase in the projection of the legs from the housing.

It is preferable that a leg maximum detection unit which detects whether the legs are extended to the maximum is further provided. In this case, the inclination correction unit controls the leg extension and contraction drive unit in such a manner as to contract the leg positioned on the upper side of inclination of the housing when the leg maximum detection unit detects that the leg positioned on the lower side of inclination of the housing is the maximum.

According to this structure, the inclination correction unit controls the leg extension and contraction drive unit in such a manner as to contract the leg positioned on the upper side of inclination of the housing when the leg maximum detection unit detects that the leg positioned on the lower side of inclination of the housing is the maximum. Thus, even when the leg is extended to the maximum, inclination of the housing in the left-right direction can be corrected by contracting the opposite leg. Accordingly, the range of correction can be widened. The expression “contraction” refers to decrease in the projection of the legs from the housing.

It is preferable that the inclination correction unit controls the leg extension and contraction drive unit in such a manner as to contract the leg contained in the legs disposed on the left and right parts and positioned on the upper side of inclination of the housing with respect to the horizontal surface based on the inclination information outputted from the inclination detection unit.

According to this structure, the inclination correction unit controls the leg extension and contraction drive unit in such a manner as to contract the leg positioned on the upper side of inclination of the housing. Thus, inclination of the projector housing in the left-right direction is controlled such that the position of the leg on the upper side can be adjusted to the position of the leg on the lower side.

It is preferable that a leg minimum detection unit which detects whether the legs are contracted to the minimum is further provided. In this case, the inclination correction unit controls the leg extension and contraction drive unit in such a manner as to extend the leg positioned on the lower side of inclination of the housing when the leg minimum detection unit detects that the leg positioned on the upper side of inclination of the housing is the minimum.

According to this structure, the inclination correction unit controls the leg extension and contraction drive unit in such a manner as to extend the leg positioned on the lower side of inclination of the housing when the leg minimum detection unit detects that the leg positioned on the upper side of inclination of the housing is the minimum. Thus, even when the leg is contracted to the minimum, inclination of the housing in the left-right direction can be corrected by extending the opposite leg. Accordingly, the range of correction can be widened.

It is preferable that an extension detection unit which detects extension of the legs and an extension memory unit which stores extension of the legs obtained after the inclination correction unit corrects inclination of the housing in the left-right direction are further provided. In this case, the inclination correction unit controls the leg extension and contraction drive unit such that the legs have extension corresponding to the extension stored in the extension memory unit when receiving a predetermined command signal.

According to this structure, the extension memory unit stores extension of the leg obtained after the inclination correction unit corrects inclination of the housing in the left-right direction, and the inclination correction unit controls the leg extension and contraction drive unit such that extension of the leg corresponds to the extension stored in the extension memory unit. Thus, inclination of the housing in the left-right direction can be easily corrected when the projector is used at the place where extension is stored. The expression “extension” refers to projection of the leg from the housing.

It is preferable that the inclination detection unit has a pair of contact detection members disposed symmetric around the pendulum in the left-right direction with a predetermined distance between the contact detection members, and detects inclination of the housing in the left-right direction by contact between the pendulum and either of the two contact detection members.

According to this structure, inclination of the housing in the left-right direction can be detected by contact between the pendulum and either of the two contact detection members. Thus, inclination direction can be detected by a simple structure.

### BRIEF DESCRIPTION OF THE DRAWINGS

The invention will be described with reference to the accompanying drawings, wherein like numbers reference like elements.

FIG. 1 is a perspective view illustrating an external appearance of a projector according to a first embodiment.

FIG. 2 is a plan view illustrating an external appearance of the projector as viewed from a front surface (front).

FIG. 3 is a plan view illustrating an external appearance of the projector as viewed from a bottom surface (bottom).

FIG. 4 is a block diagram showing general structure of the projector.

FIG. 5 is a front view showing the projector inclined to the horizontal surface in the left-right direction.

FIGS. 6A through 6C illustrate detection method performed by an inclination detection unit. FIG. 6A shows condition disposing a housing in the horizontal direction. FIG. 6B shows condition disposing the housing inclined to the right, FIG. 6C shows condition disposing the housing inclined to the left.

FIG. 7 is a partial cross-sectional view of a leg and a peripheral structure of a leg extension and contraction drive unit as viewed from the front, where projection of the leg is controlled.

FIG. 8 is a partial cross-sectional view of the leg and the peripheral structure of the leg extension and contraction drive unit as viewed from the front, where projection of the leg is the maximum.

FIG. 9 is a partial cross-sectional view of the leg and the peripheral structure of the leg extension and contraction drive unit as viewed from the front, where projection of the leg is the minimum.

FIG. 10 illustrates an extension and contraction setting information setting screen.

FIG. 11 illustrates an automatic horizontal control setting screen.

FIG. 12 is a flowchart showing automatic horizontal control process (extension pattern) performed by the projector.

FIG. 13 is a flowchart showing the automatic horizontal control process (contraction pattern) performed by the projector.

FIG. 14 is a block diagram showing general structure of a projector according to a second embodiment.

### DESCRIPTION OF EXEMPLARY EMBODIMENTS

Exemplary embodiments according to the invention are hereinafter described.

### First Embodiment

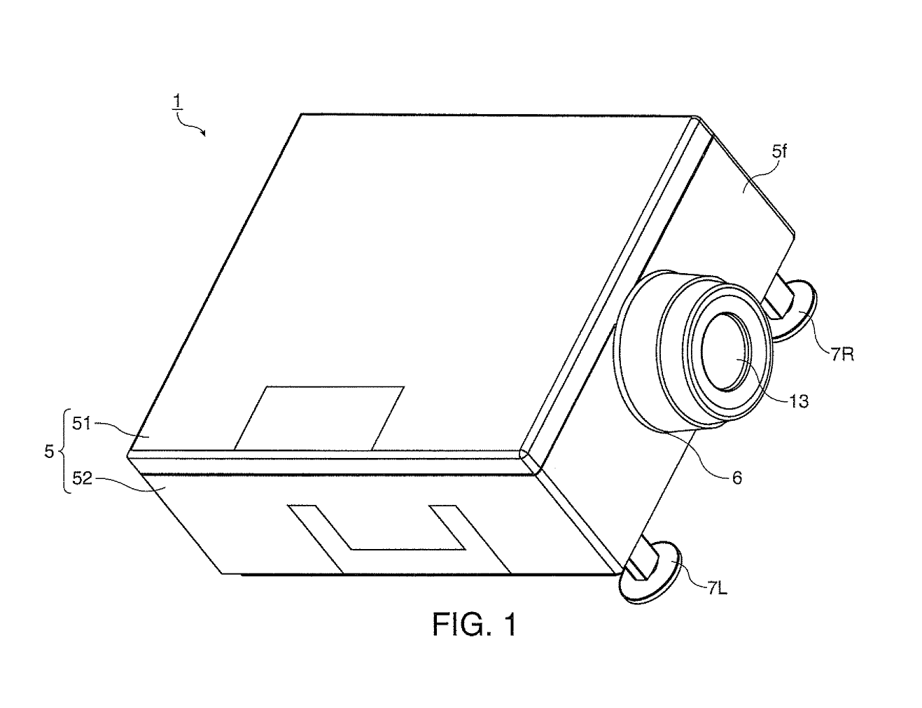

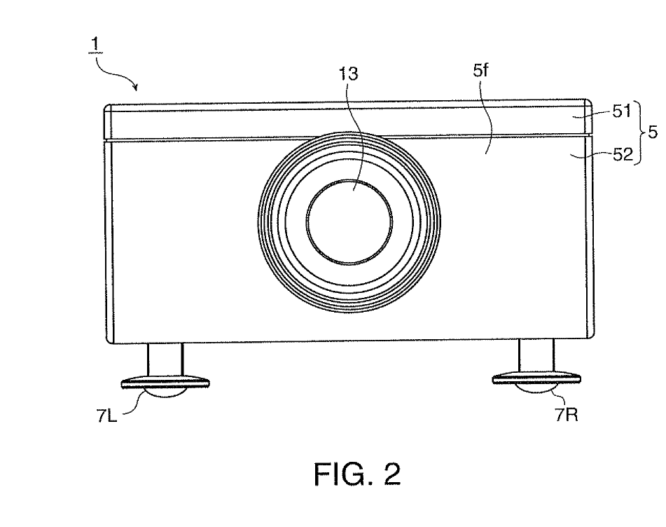

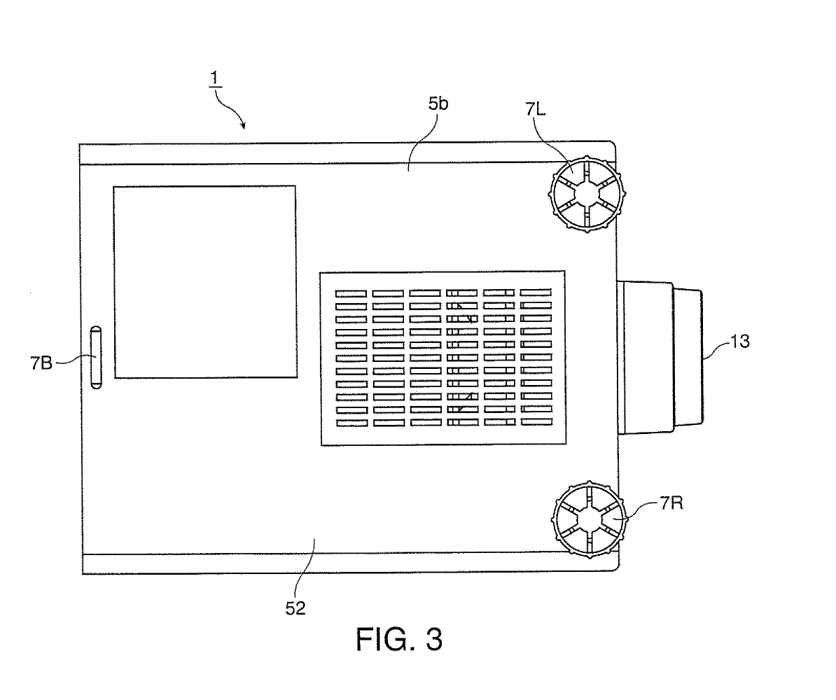

FIG. 1 is a perspective view illustrating an external appearance of a projector according to a first embodiment of the invention. FIG. 2 is a plan view illustrating an external appearance of the projector in this embodiment as viewed from the front face (front). FIG. 3 is a plan view illustrating an external appearance of the projector in this embodiment as viewed from the bottom face (bottom). The structure of a projector 1 in the external appearance is now described with reference to FIGS. 1 through 3.

As illustrated in FIGS. 1 through 3, the projector 1 has an outside structure constituted by a housing 5 having an upper case 51 and a lower case 52. An opening 6 is formed at the center of a front surface 5f of the housing 5. A projection lens 13 projects through the opening 6. The projector 1 projects images on a projection surface such as a screen by using the projection lens 13. An image projection unit having a light source, a liquid crystal light valve and the like, a power source unit for supplying power to the image projection unit, a driving circuit for controlling and driving the image projection unit, and other components are accommodated within the housing 5.

A pair of legs (left leg 7L and right leg 7R) are provided on the front left and right parts of a bottom surface 5b of the housing 5. A leg (rear leg 7B) projects substantially from the rear center of the bottom surface 5b. The projector 1 is supported by these legs (left leg 7L, right leg 7R, and rear leg 7B) on an installation surface. The left leg 7L and the right leg 7R are separately extended and contracted. The user varies the projection angle by controlling extension of the left leg 7L and right leg 7R (projection from the housing 5) to control the projection position on the projection surface such as screen. In the following description, the “left” refers to the left part of the projector 1 as viewed from the front, and the “right” refers to the right part of the projector 1 as viewed from the front.

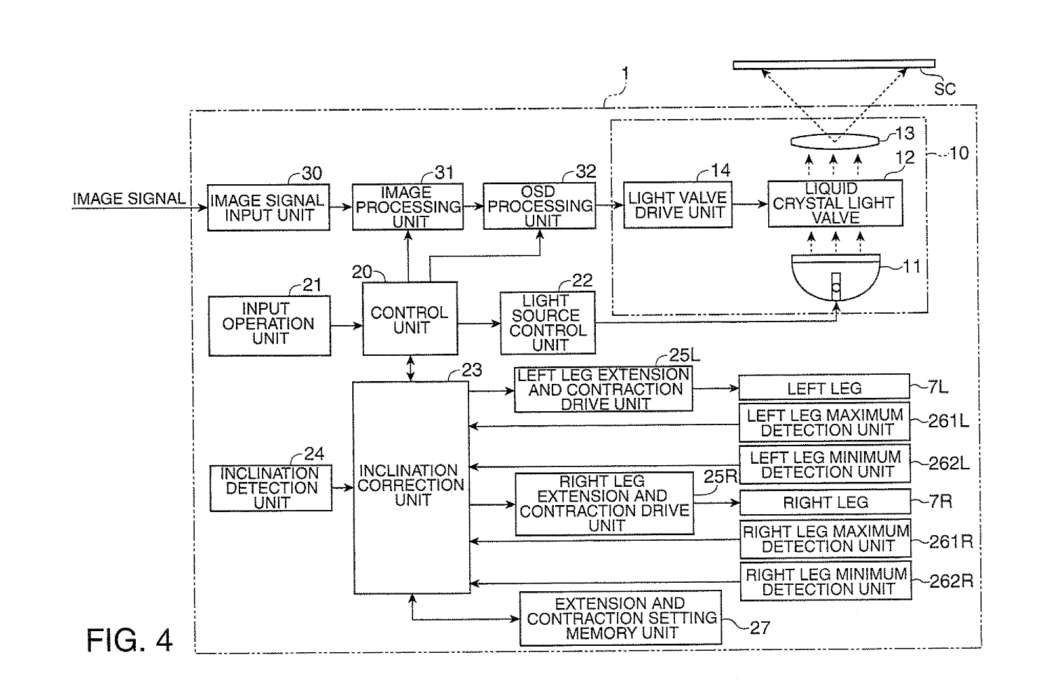

The internal structure of the projector 1 is now discussed. FIG. 4 is a block diagram showing the general structure of the projector 1 according to the first embodiment.

The projector 1 includes an image projection unit 10, a control unit 20, an input operation unit 21, a light source control unit 22, an inclination correction unit 23, an inclination detection unit 24, a left leg extension and contraction drive unit 25L and a right leg extension and contraction drive unit 25R as leg extension and contraction drive units, the left leg 7L and right leg 7R as legs, a left leg maximum detection unit 261L and a right leg maximum detection unit 261R as leg maximum detection units, a left leg minimum detection unit 262L and a right leg minimum detection unit 262R as leg minimum detection units, an extension and contraction setting memory unit 27, an image signal input unit 30, an image processing unit 31, an OSD processing unit 32, and other components. FIG. 4 also shows a screen SC outside the projector 1.

The image projection unit 10 has a light source 11 constituted by a discharge type light source such as extra-high pressure mercury lamp and metal halide lamp, or a solid light source such as LED (light emitting diode), a liquid crystal light valve 12 as a light modulation device, a projection lens 13 as a projection system, and a light valve drive unit 14 for driving the liquid crystal light valve 12.

The liquid crystal light valve 12 is constituted by a transmission type liquid crystal panel which has a pair of transparent substrates into which liquid crystals are sealed, for example. When drive voltage is applied to respective pixels on the liquid crystal light valve 12 according to image signals, the pixels transmit light emitted from the light source with light transmissivity corresponding to the image signals.

Light emitted from the light source 11 is modulated while passing the liquid crystal light valve 12. The modulated light is projected by the projection lens 13 to display images corresponding to the image signals on the screen SC or the like.

The control unit 20 includes CPU (central processing unit), RAM (random access memory) for temporarily storing various types of data, and non-volatile memory (not shown) such as mask RON (read only memory), flash memory, FeRAM (ferroelectric RAM: ferroelectric memory), and other sections to function as a computer. The control unit 20 unifies and controls the operation of the projector 1 by operation of the CPU under control program stored in the non-volatile memory.

The input operation unit 21 has a plurality of keys and the like through which various commands are issued to the projector 1. The keys provided on the input operation unit 21 involve “power source key” for turning on and off the power source, “menu key” for switching display/non-display on the menu screen for various setting, “cursor key” for shifting cursor on the menu screen and the like, “decision key” for deciding various settings, and other keys. When the user operates the input operation unit 21, the input operation unit 21 outputs operation signals corresponding to the operation of the user to the control unit 20. The input operation unit 21 may have a structure including a remote controller (not shown) capable of performing remote operation for a remote control signal receiving unit (not shown). In this case, the remote controller emits infrared light operation signals corresponding to the operation of the user, and the remote controller signal receiving unit receives these operation signals and transmits the signals to the control unit 20.

The light source control unit 22 controls supply and stop of power for the light source 11 to switch turning on and off of the light source 11.

The inclination detection unit 24 includes a pendulum, and outputs inclination information whether the pendulum is inclined either to the left or to the right to the inclination correction unit 23.

When receiving a command from the control unit 20, the inclination correction unit 23 controls the left leg extension and contraction drive unit 25L or the right leg extension and contraction drive unit 25R to extend or contract the left leg 7L or the right leg 7R and correct inclination of the housing 5 of the projector 1 in the left-right direction based on the inclination information outputted from the inclination detection unit 24. Correction of inclination of the housing 5 of the projector 1 in the left-right direction by the inclination correction unit 23 is hereinafter referred to as “automatic horizontal control” as well.

In the automatic horizontal control, the inclination correction unit 23 determines whether the legs are to be extended or contracted for correction based on the extension and contraction setting information stored in the extension and contraction setting memory unit 27. The inclination correction unit 23 switches which leg is to be extended or contracted based on the information about the extension and contraction condition of the legs outputted from the left leg maximum detection unit 261L, right leg maximum detection unit 261R, the left leg minimum detection unit 262L, and the right leg minimum detection unit 262R as necessary.

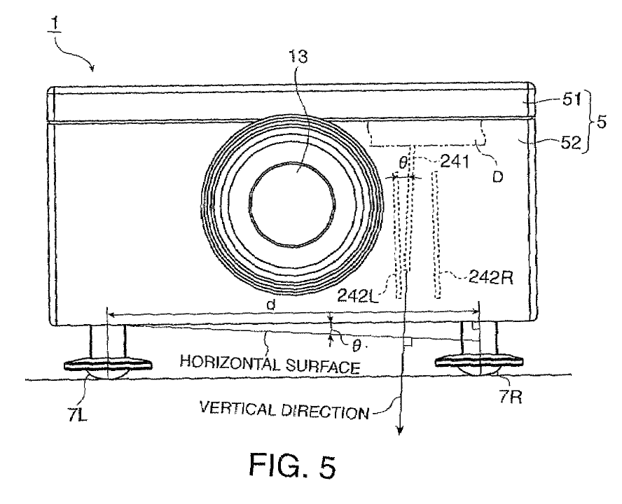

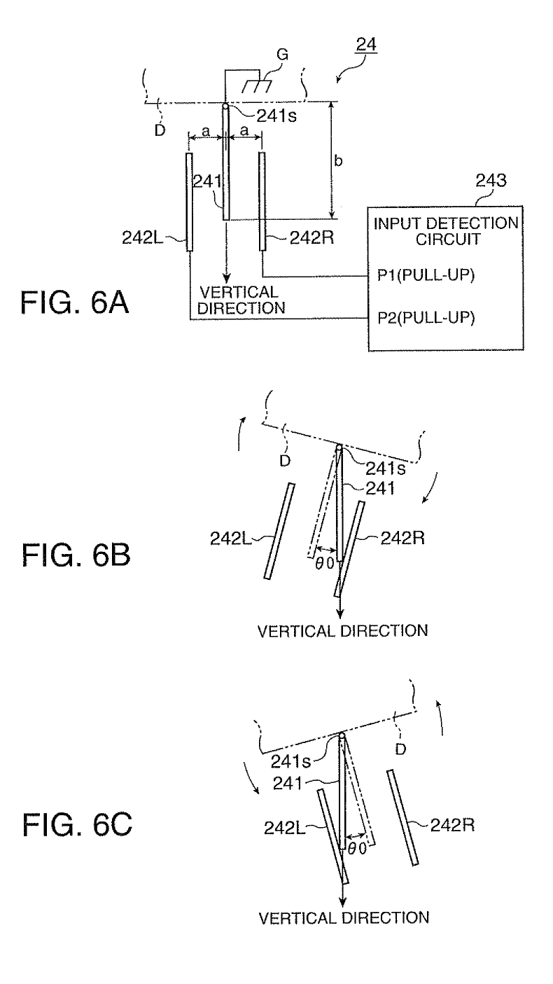

The inclination detection unit 24 is now discussed with reference to FIGS. 5 and 6A through 6C.

FIG. 5 is a front view showing a condition of the projector 1 inclined in the left-right direction with respect to the horizontal surface. FIGS. 6A through 6C illustrate a detection method performed by the inclination detection unit 24. FIG. 6A shows a condition of the housing 5 placed horizontally, FIG. 6B shows a condition of the housing 5 inclined to the right, and FIG. 6C shows a condition of the housing 5 inclined to the left. FIGS. 6A through 6C illustrate the projector 1 as viewed from the front.

A pendulum 241, and a left contact detection plate 242L and a right contact detection plate 242R as contact detection members are provided as components of the inclination detection unit 24 within the housing 5. The pendulum 241 is disposed on a shaft 241s fixed to a predetermined portion D of the housing 5 and extending in the front-rear direction in such a manner as to swing in the left-right direction. The pendulum 241 has a length b. The left contact detection plate 242L and the right contact detection plate 242R are disposed symmetric in the left-right direction (symmetric in the left-right direction of the housing 5) around the pendulum 241 with a predetermined distance a left between the left and right contact detection plates 242L and 242R. The left contact detection plate 242L and the right contact detection plate 242R are supported by and fixed to the housing 5 by a not-shown supporting member in such positions as to be parallel with and opposed to each other. The inclination detection unit 24 has an input detection circuit 243 for detecting whether the pendulum 241 contacts the left contact detection plate 242L or the right contact detection plate 242R.

The pendulum 241 is formed by a metal bar having conductivity. The left contact detection plate 242L and the right contact detection plate 242R are formed by metal plates having conductivity. As illustrated in FIG. 6A, the pendulum 241 is electrically grounded to a ground G. The left contact detection plate 242L is connected with an input port P2 of the input detection circuit 243, and the right contact detection plate 242R is connected with an input port P1 of the input detection circuit 243. The input ports P1 and P2 of the input detection circuit 243 are under pull-up condition.

As illustrated in FIG. 5, inclination of the projector 1 in the left-right direction is represented by inclination angle θ of the housing 5 to the horizontal surface. Since the pendulum 241 can swing, the lower end of the pendulum 241 is directed in the vertical direction (downward direction) by gravity. Thus, the angle of the pendulum 241 to the contact detection plates (left contact detection plate 242L in the figure) becomes the same angle as the inclination angle θ of the housing 5.

When the housing 5 is placed on the horizontal surface without inclination in the left-right direction, the pendulum 241 is positioned parallel with the left contact detection plate 242L and the right contact detection plate 242R as illustrated in FIG. 6A. In this case, both the potential conditions of the input ports P1 and P2 detected by the input detection circuit 243 become “H (high)” by pull-up.

When the housing 5 is inclined to the horizontal surface at an angle equal to or larger than a predetermined angle θ0 (inclined in the direction indicated by an arrow in the figure) such that the right side shifts downward (left side shifts upward), the pendulum 241 contacts the right contact detection plate 242R as illustrated in FIG. 6B. In this case, the potential condition of the input port P1 detected by the input detection circuit 243 becomes “L (low)” by ground connection, and the potential condition of the input port P2 becomes “H”.

When the housing 5 is inclined to the horizontal surface at an angle equal to or larger than the predetermined angle θ0 (inclined in the direction indicated by an arrow in the figure) such that the left side shifts downward (right side shifts upward), the pendulum 241 contacts the left contact detection plate 242L as illustrated in FIG. 6C. In this case, the potential condition of the input port P1 detected by the input detection circuit 243 becomes “H”, and the potential condition of the input port P2 becomes “L” by ground connection.

When the housing 5 is inclined to the horizontal surface in the right or left direction at an angle smaller than the predetermined angle θ0, the pendulum 241 contacts neither the left contact detection plate 242L nor the right contact detection plate 242R. In this case, both the potential conditions of the input ports P1 and P2 detected by the input detection circuit 243 become “H”.

Thus, it can be judged whether the pendulum 241 contacts the left contact detection plate 242L, the right contact detection plate 242R, or neither of these plates 242L and 242R based on the potential conditions of the input ports P1 and P2 detected by the input detection circuit 243. By this method, it can be determined whether the housing 5 of the projector is inclined to the horizontal surface at an angle equal to or larger than the predetermined angle θ0 in the left direction or inclined to the horizontal surface at an angle equal to or larger than the predetermined angle θ0 in the right direction, or whether the inclination angle is smaller than the predetermined angle θ0. When the predetermined angle θ0 is sufficiently small, it is judged that the housing 5 is positioned substantially in the horizontal condition based on the potential conditions of the input ports P1 and P2 as “H”. The inclination detection unit 24 outputs three types of information of “left inclination”, “right inclination”, and “horizontal” as inclination information.

The distance a, the length b, and the predetermined angle θ0 have the relationship expressed by the following equation (1).

a=b·sin θ0 (1)

As can be seen from the equation (1), the accuracy for the judgment that the housing 5 is substantially horizontal can be increased by reducing the distance a or increasing the length b (that is, decreasing the predetermined angle θ0).

Returning to FIG. 4, the left leg extraction and contraction drive unit 25L has motor, gear and other components, and extracts and contracts the left leg 7L under the control of the inclination correction unit 23. Similarly, the right leg extraction and contraction drive unit 25R has motor, gear and other components, and extracts and contracts the right leg 7R under the control of the inclination correction unit 23.

The left leg 7L is driven by the left leg extension and contraction drive unit 25L to extend (increase projection from the housing 5) or contract (decrease projection from the housing 5). Similarly, the right leg 7R is driven by the right leg extension and contraction drive unit 25R to extend or contract.

The left leg maximum detection unit 261L detects whether the extension of the left leg 7L is the maximum (projection from the housing 5 is the maximum). Similarly, the right leg maximum detection unit 261R detects whether the extension of the right leg 7R is the maximum (projection from the housing 5 is the maximum). Then, the left and right leg maximum detection units 261L and 261R output the detection results to the inclination correction unit 23 as information about the extension and contraction condition of the legs.

The left leg minimum detection unit 262L detects whether the extension of the left leg 7L is the minimum (projection from the housing 5 is the minimum). Similarly, the right leg minimum detection unit 262R detects whether the extension of the right leg 7R is the minimum (projection from the housing 5 is the minimum). Then, the left and right leg minimum detection units 262L and 262R output the detection results to the inclination correction unit 23 as information about the extension and contraction condition of the legs.

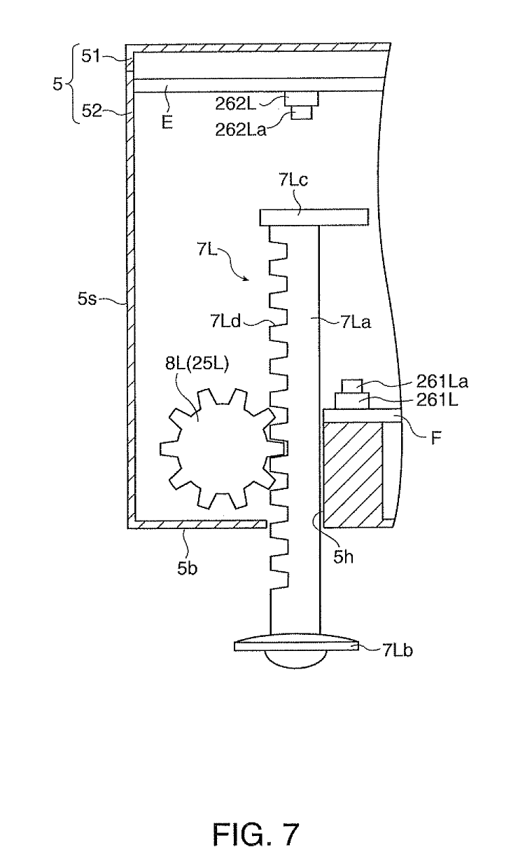

The extending and contracting operations of the legs are now discussed with reference to FIGS. 7 through 9.

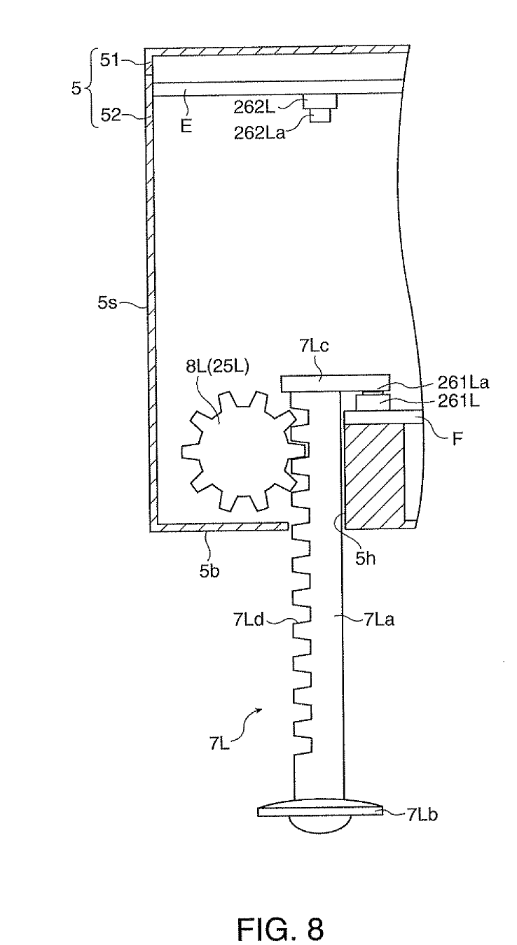

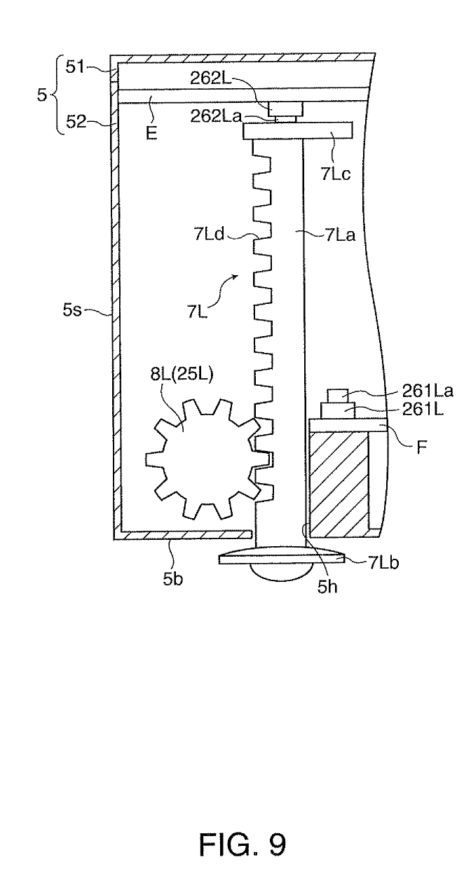

FIG. 7 is a partial cross-sectional view illustrating a peripheral structure of the leg and the leg extension and contraction drive unit as viewed from the front, showing a condition controlling the projection of the leg. FIG. 8 is a partial cross-sectional view illustrating a peripheral structure of the leg and the leg extension and contraction drive unit as viewed from the front, showing a condition of the maximum projection of the leg. FIG. 9 is a partial cross-sectional view illustrating a peripheral structure of the leg and the leg extension and contraction drive unit as viewed from the front, showing a condition of the minimum projection of the leg. These figures show only the left leg 7L (left side). The leg 7R (right side) has substantially similar structure (symmetric in the left-right direction), and therefore figure and explanation of the leg 7R are not shown herein.

As illustrated in FIGS. 7 through 9, the left leg 7L has a cylindrical leg main body 7La, a lower end 7Lb disposed at one end (lower end) of the leg main body 7La and contacting the installation surface, and an upper end 7Lc disposed at the other end (upper end) of the leg main body 7La. These component 7La through 7Lc are combined as one piece. The leg main body 7La is inserted through a hole 5h formed on the bottom surface 5b of the housing 5 such that the leg main body 7La can slide in the hole 5h, and positioned substantially in vertical condition with respect to the bottom surface 5b of the housing 5. A rack-shaped engaging portion 7Ld is formed on the surface of the leg main body 7La facing the housing side surface (side surface 5s) closest to the leg main body 7La. The engaging portion 7Ld has a plurality of grooves formed in the front-rear direction at equal intervals in the up-down direction. The lower end 7Lb and the upper end 7Lc have larger width than that of the leg main body 7La so as to prevent separation of the leg main body 7La through the hole 5h.

The left leg extension and contraction drive unit 25L has a motor (not shown) and a pinion gear 8L. The pinion gear 8L engages with the rack-shaped engaging portion 7Ld of the leg 7L. The pinion gear 8L is fixed to a motor shaft (not shown) of the motor. When the motor is driven, the motor shaft rotates, thereby rotating the pinion gear 8L. The motor is constituted by a DC motor, stepping motor, or other motor.

When the pinion gear 8L rotates, the rack-shaped engaging portion 7Ld slides in the up-down direction. As a result, the leg 7L shifts in the up-down direction. Accordingly, the projection (extension) of the leg 7L varies.

The left leg maximum detection unit 261L is mounted as a press switch (hereinafter referred to as “press switch 261L” as well) on the upper surface of a circuit substrate F inside the housing 5. The press switch 261L has a button 261La to be pressed downward. The button 261La is constantly urged upward by a not-shown spring provided inside the press switch 261L.

When the leg 7L is extended to have the maximum length, the button 261La of the press switch 261L is pressed downward by the lower surface of the upper end 7Lc of the leg 7L as illustrated in FIG. 8. In this case, the press switch 261L is turned on, and detects that the projection (extension) of the left leg 7L is the maximum. When the leg 7L is contracted, the button 261La projects upward by the urging force of the spring as illustrated in FIGS. 7 and 9. In this case, the press switch 261L is turned off, and detects that the projection (extension) of the left leg 7L is not the maximum. Thus, the projector 1 can detect whether the leg 7L is the maximum based on the condition (on or off) of the press switch 261L.

Since the surroundings of the right leg 7R have substantially similar structure as described above, the press switch 261R as the right leg maximum detection unit 261R is provided within the housing 5.

The left leg minimum detection unit 262L is mounted as a press switch (hereinafter referred to as “press switch 262L” as well) on the lower surface of a circuit substrate E inside the housing 5. The press switch 262L has a button 262La to be pressed upward. The button 262La is constantly urged downward by a not-shown spring provided inside the press switch 262L.

When the leg 7L is contracted to have the minimum length, the button 262La of the press switch 262L is pressed upward by the upper end 7Lc of the leg 7L as illustrated in FIG. 9. In this case, the press switch 262L is turned on, and detects that the projection (extension) of the left leg 7L is the minimum. When the leg 7L is extended, the button 262La projects downward by the urging force of the spring as illustrated in FIGS. 7 and 8. In this case, the press switch 262L is turned off, and detects that the projection (extension) of the left leg 7L is not the minimum. Thus, the projector 1 can detect whether the leg 7L is the minimum based on the condition (on or off) of the press switch 262L.

Since the surroundings of the right leg 7R have substantially similar structure as described above, the press switch 262R as the right leg minimum detection unit 262R is provided within the housing 5.

Returning to FIG. 4, the extension and contraction setting memory unit 27 has a non-volatile memory, and stores extension and contraction setting information. The extension and contraction setting information is information which shows whether correction is performed by extending the leg (left leg 7L or right leg 7R), or by contracting the leg for correcting inclination of the housing 5 of the projector 1 in the left-right direction (automatic horizontal control). The extension and contraction setting information is written or read by the inclination correction unit 23. In this embodiment, the extension and contraction setting information can be set by operation of the user using the input operation unit 21 via the control unit 20 and the inclination correction unit 23.

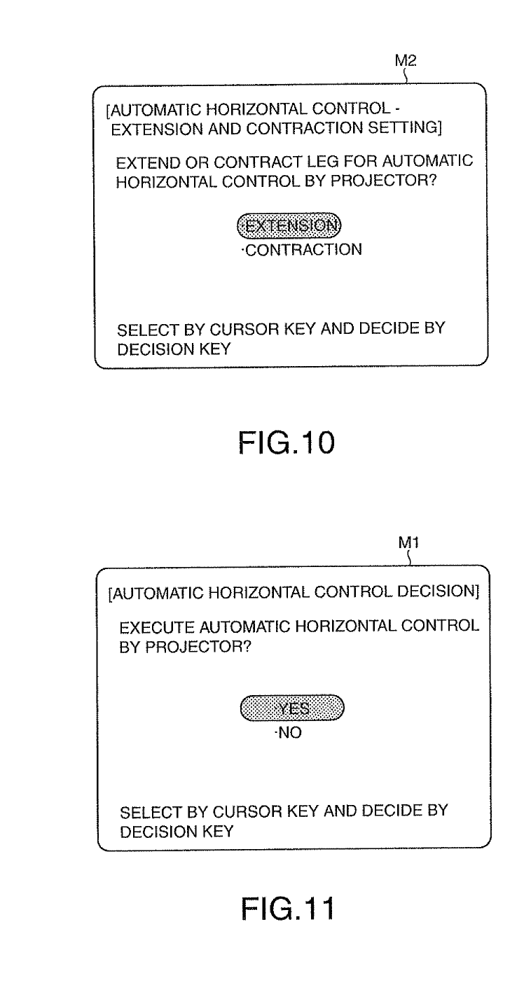

FIG. 10 illustrates an extension and contraction setting information setting screen. An extension and contraction setting information setting screen M2 is a screen for setting the extension and contraction setting information by the user. In this embodiment, the extension and contraction setting information setting screen M2 is OSD display for displaying the screen by issuing commands to the OSD processing unit 32.

As illustrated in FIG. 10, the extension and contraction setting information setting screen M2 displays a message requiring selection of extension or contraction of the leg in the upper region of the screen at the time of correction of the inclination of the housing 5 of the projector 1 in the left-right direction (automatic horizontal control). The extension and contraction setting information setting screen M2 also displays choices of “extension” and “contraction” in the middle of the screen, and shows explanation of the key input procedures in the lower region of the screen.

When the user sets “extension” or “contraction” on the screen by operation of the input operation unit 21, the set information is inputted to the inclination correction unit 23 via the control unit 20. Then, the inclination correction unit 23 writes the set information to the extension and contraction setting memory unit 27 as extension and contraction setting information and stores the information therein. In this embodiment, default corresponds to “extension”.

Returning to FIG. 4, the image signal input unit 30 has various types of image input pins for connection with external image supply apparatus (not shown) such as personal computer and video reproduction device via a cable so as to receive image signals from the image supply apparatus. The image signal input unit 30 converts received image signals into image data in the form allowed to be processed by the image processing unit 31 and outputs the image data to the image processing unit 31.

The image processing unit 31 performs processes for controlling brightness, contrast, sharpness, tones and the like of the image data received from the image signal input unit 30 based on the commands from the control unit 20. The image processing unit 31 outputs the controlled and processed image data to the OSD processing unit 32.

The OSD processing unit 32 superimposes OSD (on screen display) images such as menu screen and message screen on the image data received from the image processing unit 31 in response to the command issued from the control unit 20. The OSD processing unit 32 has a not-shown OSD memory, and stores OSD image data which shows figures and fonts for forming OSD images. When the control unit 20 commands superimposition of an OSD image, the OSD processing unit 32 reads necessary OSD image data from the OSD memory and combines the OSD image data with the image data received from the image processing unit 31 such that the OSD image can be superimposed at a predetermined position of the input image. The image data combined with the OSD image data is outputted to the light valve drive unit 14. When the command for superimposing the OSD image is not issued from the control unit 20, the OSD processing unit 32 outputs the image data outputted from the image processing unit 31 to the light valve drive unit 14 without change.

When the power source is turned on by the power source key of the input operation unit 21, the projector 1 in this embodiment performs necessary initial operation such as turning on the light source 11, and projects images corresponding to image signals inputted to the projector 1 from the image projection unit 10.

The projector 1 in this embodiment can select whether the automatic horizontal control is performed or not.

FIG. 11 shows an automatic horizontal control setting screen. An automatic horizontal control setting screen M1 is a screen for setting whether the automatic horizontal control is performed or not by the user. In this embodiment, the automatic horizontal control setting screen M1 is OSD display, and the OSD processing unit 32 displays the screen based on commands from the control unit 20.

As illustrated in FIG. 11, the automatic horizontal control setting screen M1 shows message requiring selection whether the automatic horizontal control is performed or not in the upper region of the screen. The automatic horizontal control setting screen M1 also shows choices of “yes” or “no” in the middle of the screen, and shows explanation of the key input procedures in the lower region of the screen.

When the user selects “yes” or “no” on the screen by operation of the input operation unit 21, an input operation signal is supplied to the inclination correction unit 23 via the control unit 20, and stored in a not-shown automatic horizontal control setting memory unit as automatic horizontal control set value. When “yes” is selected, this selection is stored as “set on”. When “no” is selected, this selection is stored as “set off”. When the automatic horizontal control setting of the automatic horizontal control setting memory unit is “set on”, the inclination correction unit 23 performs the automatic horizontal control. In this embodiment, default corresponds to “yes”.

According to this embodiment, the automatic horizontal control is executed at the time when the power source key of the input operation unit 21 is operated to turn on the power source of the projector 1. In case of a projector which automatically corrects trapezoidal distortion as disclosed in JP-A-2003-283963, the automatic horizontal control may be conducted at the time of performing the trapezoidal distortion correction,

The details of automatic horizontal control process are now described.

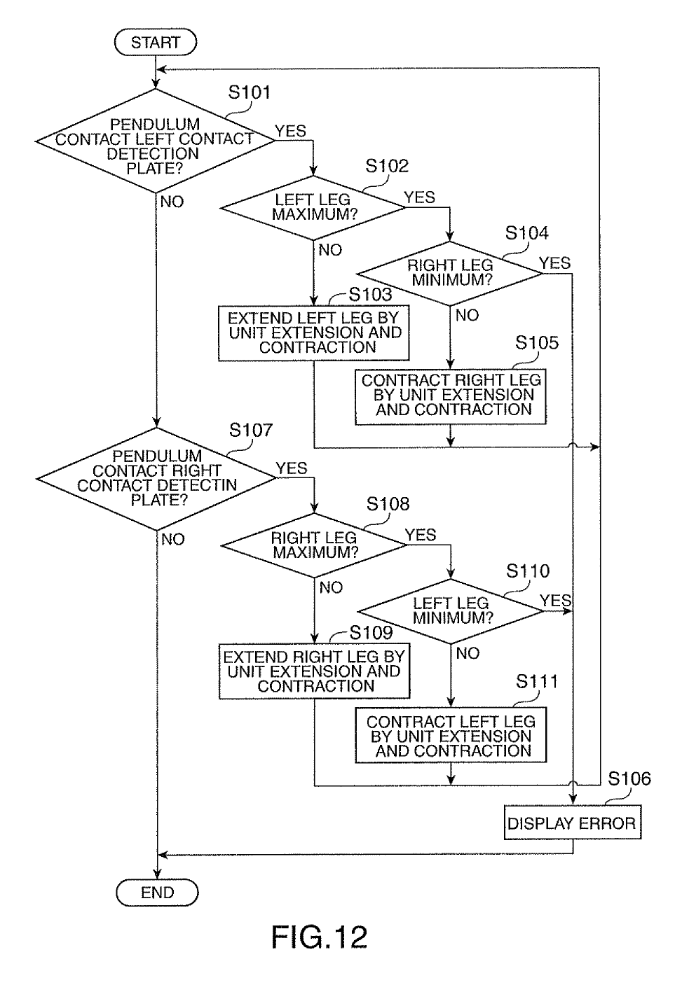

FIG. 12 is a flowchart showing the automatic horizontal control process (extension pattern) performed by the projector 1. When the projector 1 is turned on under the condition of “set on” in the automatic horizontal control setting and “extension” in the extension and contraction setting information setting described above, the projector 1 operates according to the process flow shown in FIG. 12.

The inclination correction unit 23 judges whether the pendulum 241 contacts the left contact detection plate 242L, that is, whether the housing 5 is “inclined to the left” based on inclination information outputted from the inclination detection unit 24 (step S101). When the pendulum 241 contacts the left contact detection plate 242L (step S101: YES), the inclination correction unit 23 judges whether extension of the left leg 7L is the maximum based on information outputted from the left leg maximum detection unit 261L (step S102). When the extension of the left leg 7L is not the maximum (step S102: NO), the inclination correction unit 23 issues a command to the left leg extension and contraction drive unit 25L to extend the left leg 7L by unit extension and contraction (step S103). Then, the process goes to step S101 and again detects inclination of the pendulum 241.

Assuming that the unit extension and contraction is Δh, that variation of inclination angle of the housing 5 when the leg is extended by the unit extension and contraction Δh is Δθ, and that the distance between the left leg 7L and the right leg 7R is d (see FIG. 5), the relationship between the unit extension and contraction Δh and the angle variation Δθ have the relationship expressed by the following equation (2).

Δh=d·tan Δθ (2)

For determining the unit extension and contraction Δh, the unit extension and contraction Δh needs to be set according to the swing range of the pendulum 241 included in the inclination detection unit 24 (that is, considering the predetermined angle θ0). More specifically, when the leg extension and contraction drive unit extends or contracts the leg by the unit extension and contraction Δh, the unit extension and contraction Δh (that is, the angle variation Δθ) needs to be determined in such a manner as to prevent shift of the pendulum 241 from the condition contacting the left contact detection plate 242L to the condition contacting the right contact detection plate 242R and shift of the pendulum 241 from the condition contacting the right contact detection plate 242R to the condition contacting the left contact detection plate 242L. Thus, the relationship between the angle variation Δθ and the predetermined angle θ0 is established such that the following equation (3) holds.

Δθ<2·θ0 (3)

The variation Δθ is determined such that the equation (3) can be satisfied, and then the unit extension and contraction Δh is determined. The leg extension and contraction drive unit extends or contracts the leg by the unit extension and contraction Δh unit by unit. As a result, the pendulum 241 can be brought into a substantially horizontal condition contacting neither the left contact detection plate 242L nor the right contact detection plate 242R, and the inclination detection unit 24 can detect three types of information “left inclination”, “horizontal”, and “right inclination” as inclination information.

Returning to the flowchart in FIG. 12, the inclination correction unit 23 judges whether the extension of the right leg 7R is the minimum based on the information outputted from the right leg minimum detection unit 262R (step S104) when the extension of the left leg 7L is the maximum (step S102: YES). When the extension of the right leg 7R is not the minimum (step S104: NO), the inclination correction unit 23 issues a command to the right leg extension and contraction drive unit 25R to contract the right leg 7R by the unit extension and contraction Δh (step S105). Then, the process goes to step S101 to again detect inclination of the pendulum 241.

When extension of the right leg 7R is the minimum (step S104: YES), the inclination correction unit 23 judges that control is impossible, and outputs a signal indicating that the leg control is impossible to the control unit 20. The control unit 20 displays control error (not shown) based on the signal (step S106), and the automatic horizontal control process ends. The display showing the control error is OSD display, for example, which is shown in response to a command from the control unit 20 to the OSD processing unit 32. Alternatively, display of the control error may be indicated by light emission color or light emission pattern produced by an LED display unit or the like (not shown),

When the pendulum 241 does not contact the left contact detection plate 242L (step S101: NO), the inclination correction unit 23 judges whether the pendulum 241 contacts the right contact detection plate 242R, that is, whether the housing 5 is “inclined to the right” (step S107). When the pendulum 241 contacts the right contact detection plate 242R (step S107: YES), the inclination correction unit 23 judges whether the extension of the right leg 7R is the maximum based on the information outputted from the right leg maximum detection unit 261R (step S108). When the extension of the right leg 7R is not the maximum (step S108: NO), the inclination correction unit 23 issues a command to the right leg extension and contraction drive unit 25R to extend the right leg 7R by the unit extension and contraction Δh (step S109). Then, the process goes to step S101 to again detect inclination of the pendulum 241.

When extension of the right leg 7R is the maximum (step S108: YES), the inclination correction unit 23 judges whether extension of the left leg 7L is the minimum based on the information outputted from the left leg minimum detection unit 262L (step S110). When extension of the left leg 7L is not the minimum (step S110: NO), the inclination correction unit 23 issues a command to the left leg extension and contraction drive unit 25L to contract the left leg 7L by the unit extension and contraction Δh (step S111). Then, the process goes to step S101 to again detect inclination of the pendulum 241.

When extension of the left leg 7L is the minimum (step S110: YES), the inclination correction unit 23 judges that control is impossible, and outputs a signal indicating that the leg control is impossible to the control unit 20. The control unit 20 displays control error (not shown) based on the signal (step S106), and the automatic horizontal control process ends.

When the pendulum 241 does not contact the right contact detection plate 242R (step S107: NO), the inclination correction unit 23 judges that the housing 5 is substantially “horizontal”, and ends the automatic horizontal control process.

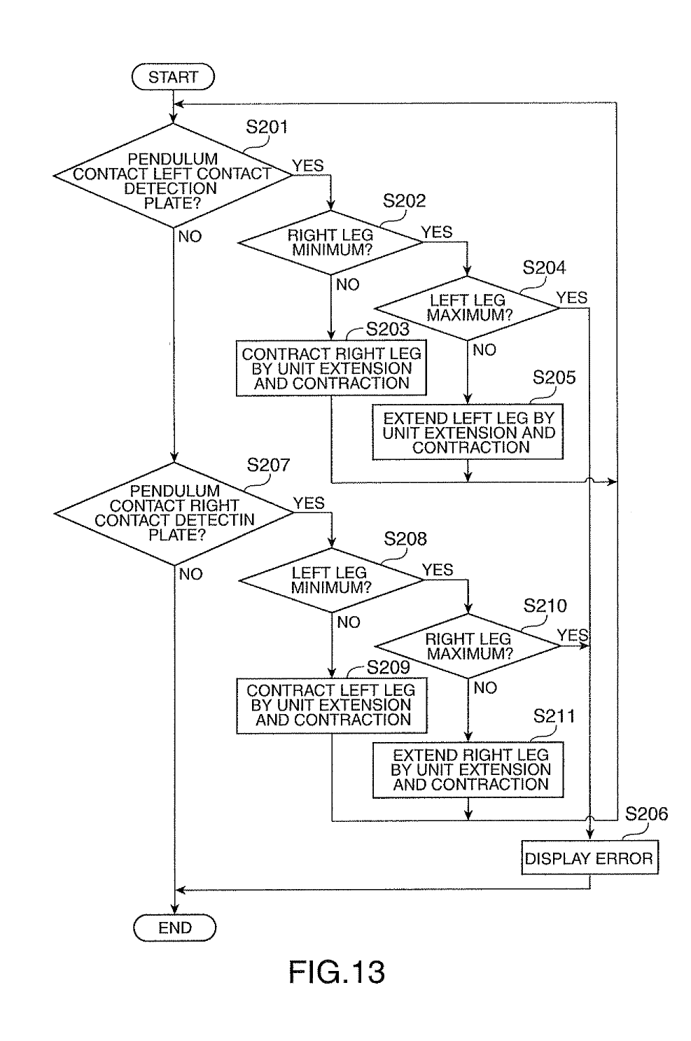

FIG. 13 is a flowchart showing automatic horizontal control process (contraction pattern) performed by the projector 1. When the projector 1 is turned on under the condition “set on” in the automatic horizontal control setting and “contraction” in the extension and contraction setting information setting described above, the projector 1 operates according to the process flow shown in FIG. 13.

The inclination correction unit 23 judges whether the pendulum 241 contacts the left contact detection plate 242L, that is, whether the housing 5 is “inclined to the left” based on inclination information outputted from the inclination detection unit 24 (step S201). When the pendulum 241 contacts the left contact detection plate 242L (step S201: YES), the inclination correction unit 23 judges whether extension of the right leg 7R is the minimum based on information outputted from the right leg minimum detection unit 262R (step S202). When the extension of the right leg 7R is not the minimum (step S202: NO), the inclination correction unit 23 issues a command to the right leg extension and contraction drive unit 25R to contract the right leg 7L by unit extension and contraction Δh (step 5203). Then, the process goes to step S201 and again detects inclination of the pendulum 241.

When the extension of the right leg 7R is the minimum (step S202: YES), the inclination correction unit 23 judges whether the extension of the left leg 7L is the maximum based on the information outputted from the left leg maximum detection unit 261L (step S204). When the extension of the left leg 7L is not the maximum (step S204: NO), the inclination correction unit 23 issues a command to the left leg extension and contraction drive unit 25L to extend the left leg 7L by the unit extension and contraction Δh (step S205). Then, the process goes to step S201 to again detect inclination of the pendulum 241.

When extension of the left leg 7L is the maximum (step S204: YES), the inclination correction unit 23 judges that control is impossible, and outputs a signal indicating that the leg control is impossible to the control unit 20. The control unit 20 displays control error (not shown) based on the signal (step S206), and the automatic horizontal control process ends. In this embodiment, the display showing the control error is similar to that in step S106 of the flowchart shown in FIG. 12.

When the pendulum 241 does not contact the left contact detection plate 242L (step S201: NO), the inclination correction unit 23 judges whether the pendulum 241 contacts the right contact detection plate 242R, that is, whether the housing 5 is “inclined to the right” (step S207). When the pendulum 241 contacts the right contact detection plate 242R (step S207: YES), the inclination correction unit 23 judges whether the extension of the left leg 7L is the minimum based on the information outputted from the left leg minimum detection unit 262L (step S208). When the extension of the left leg 7L is not the minimum (step S208: NO), the inclination correction unit 23 issues a command to the left leg extension and contraction drive unit 25L to contract the left leg 7L by the unit extension and contraction Δh (step S209). Then, the process goes to step S201 to again detect inclination of the pendulum 241.

When extension of the left leg 7L is the minimum (step S208: YES), the inclination correction unit 23 judges whether extension of the right leg 7R is the maximum based on the information outputted from the right leg maximum detection unit 261R (step S210). When extension of the right leg 7R is not the maximum (step S210: NO), the inclination correction unit 23 issues a command to the right leg extension and contraction drive unit 25R to extend the right leg 7R by the unit extension and contraction Δh (step S211). Then, the process goes to step S201 to again detect inclination of the pendulum 241.

When extension of the right leg 7R is the maximum (step S210: YES), the inclination correction unit 23 judges that control is impossible, and outputs a signal indicating that the leg control is impossible to the control unit 20. The control unit 20 displays control error (not shown) based on the signal (step S206), and the automatic horizontal control process ends.

When the pendulum 241 does not contact the right contact detection plate 242R (step S207: NO), the inclination correction unit 23 judges that the housing 5 is substantially “horizontal”, and ends the automatic horizontal control process.

As discussed above, the projector 1 extends or contracts the left leg 7L or the right leg 7R by unit extension and contraction Δh unit by unit by performing the automatic horizontal control process until the housing 5 becomes substantially “horizontal” when the housing 5 is “inclined to the left” or “inclined to the right”.

According to this embodiment, the following advantages are provided.

(1) The projector 1 corrects inclination in the left-right direction by detecting inclination of the housing 5 in the left-right direction based on the inclination condition of the pendulum 241 and extending or contracting the left leg 7L or right leg 7R. Thus, the housing 5 of the projector 1 can be positioned substantially horizontal in the left-right direction by simply using the pendulum 241, and thus images projected by the projector 1 can be positioned substantially horizontal.

(2) The projector 1 extends the leg on the lower side with respect to inclination of the housing 5 and corrects inclination of the housing 5 in the left-right direction by performing the automatic horizontal control process (extension pattern). Thus, inclination of the housing 5 in the left-right direction can be adjusted to inclination of the housing 5 of the projector 1 on the upper side of the inclination such that the housing 5 can be positioned substantially horizontal in the left-right direction.

(3) When the projector 1 detects that the leg on the lower side of inclination of the housing 5 is the maximum, the projector 1 contracts the leg on the upper side of the inclination of the housing 5 and corrects the inclination of the housing 5 in the left-right direction by performing the automatic horizontal control process (extension pattern) Thus, even when one of the legs is extended to the maximum, the housing 5 in the left-right direction can be positioned substantially horizontal by contracting the opposite leg. As a result, the correction range can be widened,

(4) The projector 1 contracts the leg on the upper side with respect to inclination of the housing 5 and corrects inclination of the housing 5 in the left-right direction by performing the automatic horizontal control process (contraction pattern). Thus, inclination of the housing 5 in the left-right direction can be adjusted to inclination of the housing 5 of the projector 1 on the lower side of the inclination such that the housing 5 can be positioned substantially horizontal in the left-right direction.

(5) When the projector 1 detects that the leg on the upper side of inclination of the housing 5 is the minimum, the projector 1 extends the leg on the lower side of the inclination of the housing 5 and corrects the inclination of the housing 5 in the left-right direction by performing the automatic horizontal control process (contraction pattern). Thus, even when one of the legs is contracted to the minimum, the housing 5 in the left-right direction can be positioned substantially horizontal by extending the opposite leg. As a result, the correction range can be widened.

(6) The projector 1 detects inclination of the housing in the left-right direction by contact between the pendulum 241 and the left contact detection plate 242L or the right contact detection plate 242R. Thus, inclination direction can be detected by simple structure including the pendulum 241.

### Second Embodiment

A second embodiment is now described.

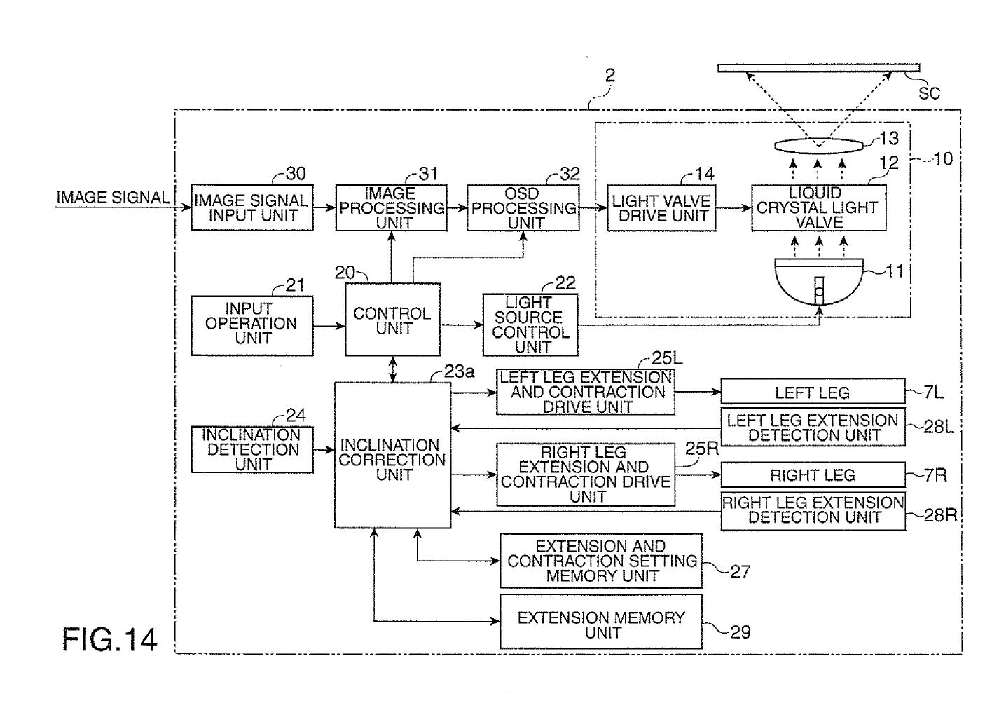

FIG. 14 is a block diagram showing a general structure of a projector 2 according to the second embodiment.

The internal structure of the projector 2 in this embodiment includes a left leg extension detection unit 28L as an extension detection unit in place of the left leg maximum detection unit 261L and the left leg minimum detection unit 262L. The structure also includes a right leg extension detection unit 28R as an extension detection unit in place of the right leg maximum detection unit 261R and the right leg minimum detection unit 262R. The structure further includes an extension memory unit 29. The operation of an inclination correction unit 23a is different from that of the inclination correction unit 23 in the first embodiment. Other structures and the like are similar to those in the first embodiment. The difference between the internal structure of the projector 2 and that of the projector 1 is now discussed with reference to FIG. 14.

The left leg extension detection unit 28L includes an encoder and other components to detect extension of the left leg 7L from the minimum to the maximum (projection from the housing 5). The encoder may be a type which detects the position of the left leg 7L in the up-down direction, or a type which detects the rotation position of the pinion gear 8L, for example. The left leg extension detection unit 28L outputs information detected using the encoder to the inclination correction unit 23a as extension of the left leg 7L. Similarly, the right leg extension detection unit 28R includes an encoder and other components to detect extension of the right leg 7R from the minimum to the maximum (projection from the housing 5). The right leg extension detection unit 28R outputs information detected using the encoder to the inclination correction unit 23a as extension of the right leg 7R.

The extension memory unit 29 has a non-volatile memory, and stores extensions of the left leg 7L and extension of the right leg 7R. These extensions are written and read by the inclination correction unit 23a.

Similarly to the first embodiment, the inclination correction unit 23a performs automatic horizontal control based on the inclination information outputted from the inclination detection unit 24. In this process, the inclination correction unit 23a determines whether the leg is extended or contracted for correction based on extension and contraction setting information stored in the extension and contraction setting memory unit 27. The inclination correction unit 23a receives extension of the leg from the left leg extension detection unit 28L and the right leg extension detection unit 28R as information about extension condition of the leg, and switches the leg to be extended or contracted as necessary.

In this embodiment, the inclination correction unit 23a receives extension of the leg from the left leg extension detection unit 28L and the right leg extension detection unit 28R in response to a command from the control unit 20, and writes the extension to the extension memory unit 29. When a predetermined command signal is received from the control unit 20, the inclination correction unit 23a controls the left leg extension and contraction drive unit 25L and the right leg extension and contraction drive unit 25R such that extension of the leg corresponds to extension stored in the extension memory unit 29, and extends or contracts the left leg 7L or the right leg 7R under this control.

The operation of the projector 2 is now discussed.

When the user executes predetermined operation through the input operation unit 21 after the automatic horizontal control by the projector 2, the control unit 20 issues a command for storing extension to the inclination correction unit 23a. The inclination correction unit 23a obtains current extension of the left leg 7L and current extension of the right leg 7R from the left leg extension detection unit 28L and the right leg extension detection unit 28R in response to the command from the control unit 20, and stores these extensions in the extension memory unit 29. In this embodiment, the predetermined operation refers to operation for requiring the projector 2 to display an extension memory setting screen (not shown) for storing extension and requiring the user to execute memory setting according to requirement on the screen. The extension memory setting screen is OSD display which displays screen by a command issued to the OSD processing unit 32 from the control unit 20.

In this embodiment, the control unit 20 outputs a signal requiring start of extension and contraction correction of the leg to the inclination correction unit 23a as a predetermined command signal when the projector 2 is turned on by the power source key of the input operation unit 21. When the signal requiring start of extension and contraction correction of the leg is inputted to the inclination correction unit 23a under the condition where extension is stored in the extension memory unit 29, the inclination correction unit 23a controls the left leg extension and contraction drive unit 25L or the right leg extension control drive unit 25R to extend or contract the left leg 7L or the right leg 7R such that extension of the leg corresponds to the stored extension.

According to the second embodiment, advantages similar to those in the first embodiment can be provided. In addition, the following advantages are obtained.

(1) The projector 2 stores extension of the legs, and extends or contracts the legs such that extension of the legs corresponds to stored extension in the next process at the time of power on of the projector 2. Thus, inclination of the housing 5 in the left-right direction can be easily corrected in short time when the projector is used at the same place where extension is stored.

The invention is not limited to the embodiments described and depicted herein, and therefore it is intended that various changes and improvements including the following modifications may be made.

### MODIFIED EXAMPLE 1

According to the embodiments, a pair of the legs (left leg 7L and right leg 7R) are provided in the left and right parts of the front region of the bottom surface 5b of the projector housing 5, and these legs are extended and contracted. However, the legs may be disposed on the left and right parts of the rear region, and extended and contracted to correct inclination of the housing 5 in the left-right direction. Alternatively, extensible and contractive legs may be provided on the left and right parts in both the front region and rear region.

### MODIFIED EXAMPLE 2

In the embodiments, the pendulum 241 in the embodiments is formed by metal bar having conductivity. However, the pendulum 241 may be made of material other than metal bar as long as it has conductivity. While the left contact detection plate 242L and the right contact detection plate 242R are formed by metal plates having conductivity, these plates 242L and 242R may be made of materials other than metal plates as long as they have conductivity and can contact the pendulum 241 by the swing of the pendulum 241.

### MODIFIED EXAMPLE 3

According to the embodiments, the pendulum 241 is formed by metal bar having conductivity, and the left contact detection plates 242L and the right contact detection plate 242R are formed by metal plates having conductivity. However, the pendulum 241 and the left and right contact detection plates 242L and 242R may be made of materials not having conductivity as long as the can detect whether the pendulum 241 contacts the left contact detection plate 242L and the right contact detection plate 242R. For example, the left and right contact detection plates 242L and 242R formed by pressure sensors can detect whether the pendulum 241 contacts the left and right contact detection plates 242L and 242R to detect inclination in the left-right direction.

### MODIFIED EXAMPLE 4

In the embodiments, the projector performs the automatic horizontal control process when the projector is turned on or when trapezoidal distortion correction is executed. However, the projector may perform the automatic horizontal control process by pressing a key provided on the input operation unit 21 for starting the automatic horizontal control. Alternatively, the projector may perform the automatic horizontal control by operation of the user through the input operation unit 21 including the item for carrying out “automatic horizontal control” on a function setting menu mounted on the projector as software. In this case, the user can execute the automatic horizontal control process at a desired time, and therefore usability of the projector improves.

### MODIFIED EXAMPLE 5

According to the second embodiment, the inclination correction unit 23a stores extension in the extension memory unit 29 in response to the predetermined operation of the user through the input operation unit 21. However, the inclination correction unit 23a may store extension in the extension memory unit 29 when the projector 2 completes the automatic horizontal control process. Alternatively, the projector 2 may extend or contract the leg such that extension of the leg corresponds to the extension stored in the extension memory unit 29 by press of a key provided on the input operation unit 21 for extension read setting.

### MODIFIED EXAMPLE 6

According to the second embodiment, the predetermined operation is operation for displaying the extension memory setting screen and requiring the user to execute memory setting on the screen. However, extension of the leg may be stored in the extension memory unit 29 by press of a key provided on the input operation unit 21 for extension read setting.

### MODIFIED EXAMPLE 7

According to the second embodiment, the left leg extension detection unit 28L and the right leg extension detection unit 28R have encoder and others. However, stepping motors may be provided as motors on the left and right leg extension and contraction drive units 25L and 25R. In this case, the step numbers of the stepping motors are only required to be counted for detection. Thus, the leg extension detection units can be simplified.

### MODIFIED EXAMPLE 8

According to the embodiments, the transmission type liquid crystal light valve 12 is used as the light modulation device. However, the light modulation device may be constituted by reflection type light modulation device such as reflection type liquid crystal light valve. Alternatively, micro-mirror array device and the like which modulates light emitted from the light source by controlling emission directions of inputted light in each micro-mirror as pixel may be employed.

The entire disclosure of Japanese Patent Application No. 2008-079955, filed Mar. 26, 2008 is expressly incorporated by reference herein.

What is claimed is:

1. A projector which projects an image, comprising:
a housing which forms an external casing of the projector;
a plurality of extensible and contractive legs which support the housing;
a leg extension and contraction drive unit which extends or contracts at least one of the plural legs;
an inclination detection unit which has a pendulum provided within the housing such that the pendulum can swing, and detects inclination of the housing with respect to a horizontal surface in the left-right direction based on inclination condition of the pendulum in the left-right direction to output inclination information based on a detection result; and
an inclination correction unit which controls the leg extension and contraction drive unit based on the inclination information outputted from the inclination detection unit to correct inclination of the housing in the left-right direction.

2. The projector according to claim 1, wherein the extensible and contractive legs are provided on both the left and right parts of the housing.

3. The projector according to claim 2, wherein the inclination correction unit controls the leg extension and contraction drive unit in such a manner as to extend the leg contained in the legs disposed on the left and right parts and positioned on the lower side of inclination of the housing with respect to the horizontal surface based on the inclination information outputted from the inclination detection unit.

4. The projector according to claim 3, further comprising:
a leg maximum detection unit which detects whether the legs are extended to the maximum,
wherein the inclination correction unit controls the leg extension and contraction drive unit in such a manner as to contract the leg positioned on the upper side of inclination of the housing when the leg maximum detection unit detects that the leg positioned on the lower side of inclination of the housing is the maximum.

5. The projector according to claim 2, wherein the inclination correction unit controls the leg extension and contraction drive unit in such a manner as to contract the leg contained in the legs disposed on the left and right parts and positioned on the upper side of inclination of the housing with respect to the horizontal surface based on the inclination information outputted from the inclination detection unit.

6. The projector according to claim 5, further comprising:
a leg minimum detection unit which detects whether the legs are contracted to the minimum,
wherein the inclination correction unit controls the leg extension and contraction drive unit in such a manner as to extend the leg positioned on the lower side of inclination of the housing when the leg minimum detection unit detects that the leg positioned on the upper side of inclination of the housing is the minimum.

7. The projector according to claim 1, further comprising:
an extension detection unit which detects extension of the legs; and
an extension memory unit which stores extension of the legs obtained after the inclination correction unit corrects inclination of the housing in the left-right direction,
wherein the inclination correction unit controls the leg extension and contraction drive unit such that the legs have extension corresponding to the extension stored in the extension memory unit when receiving a predetermined command signal.

8. The projector according to claim 1, wherein the inclination detection unit has a pair of contact detection members disposed symmetric around the pendulum in the left-right direction with a predetermined distance between the contact detection members, and detects inclination of the housing in the left-right direction by contact between the pendulum and either of the two contact detection members.
